(19) United States
(12) Patent Application Publication
(10) Pub. No.: US 2025/0084279 A1
(43) Pub. Date: Mar. 13, 2025

(54) TRANSPARENT MATTE ANTI-STAIN CORROSION-RESISTANT SURFACE COATING AND COLORED ANTI-STAIN CORROSION-RESISTANT SURFACE COATING FOR DIRECT AMBIENT TEMPERATURE MOISTURE-CURED TOPCOAT APPLICATIONS

(71) Applicant: RAYOUNG CHEMTECH INC., New Taipei City (TW)

(72) Inventor: Chih Han CHUNG, New Taipei City (TW)

(21) Appl. No.: 18/956,999

(22) Filed: Nov. 22, 2024

Related U.S. Application Data
(63) Continuation of application No. PCT/CN2023/096052, filed on May 24, 2023.

(30) Foreign Application Priority Data
May 25, 2022 (CN) 202210580182.9
May 19, 2023 (CN) 202310572758.1

(51) Int. Cl. C09D 183/06; C09D 5/08

(52) U.S. Cl. CPC C09D 183/06; C09D 5/082

(57) ABSTRACT

A transparent matte anti-stain and corrosion-resistant surface coating formable at ambient humidity as a topcoat, and a colored anti-stain and corrosion-resistant surface coating formable at ambient humidity as a topcoat are disclosed. This transparent matte anti-stain and corrosion-resistant surface coating includes a fluorinated modified polysilazane copolymer, which is composed of a fluorinated compound copolymerized with a siloxane and a polysilazane. Accordingly, this coating can be applied to easily corroded metal sheets or metal sheets with a protective primer coating (substrate) to provide anti-stain, hydrophobic, anti-graffiti, corrosion-resistant, thermal shock-resistant, and flexible properties. The coating hardens at ambient temperature and is suitable for direct outdoor use. Additionally, it can also be applied directly to corrosion-resistant metal surfaces while retaining the aforementioned properties.

### BACKGROUND OF THE INVENTION

### Field of Invention

The present invention relates to a type of surface coating, specifically a transparent matte, anti-fouling, and corrosion-resistant surface coating that can be directly applied as a topcoat at ambient temperature through moisture curing, as well as a colored anti-fouling, corrosion-resistant surface coating that can be similarly applied.

### Description of Related Art Conventional steel coatings typically require a minimum of two layers: a primer

layer followed by a color-coated steel topcoat. The purpose of the first primer layer is to enhance adhesion between the color-coated steel topcoat and the steel substrate. Common materials for primers include polyurethane resin, epoxy resin, and polyester resin, with a film thickness of approximately 5-20 μm. The second layer, the color-coated steel topcoat, serves to protect the steel from corrosion and provide an aesthetic appearance. Common materials for topcoats include fluorocarbon coatings, silicone-modified polyester resin (SMP), and polyester resin (PE), with a film thickness of about 25-30 μm. Fluorocarbon coatings may contain PVDF (polyvinylidene difluoride), FEVE (fluoroethylene vinyl ether copolymer), PTFE (polytetrafluoroethylene), among others.

For example, polyvinylidene difluoride (PVDF) is a highly non-reactive, thermoplastic fluoropolymer. It is primarily used in applications requiring solvent resistance and acid-alkali corrosion resistance. PVDF is suitable for producing pipes, sheets, films, substrates, and cable insulation sheaths, and it can also be injection molded or welded.

PVDF can be used in high-end metal coatings and is applied on many famous buildings worldwide, such as the Petronas Towers in Malaysia and Taipei 101 in Taiwan. This coating is also utilized on metal roofing in commercial buildings and residential homes. In traditional building exteriors, PVDF fluorocarbon coatings offer durability and corrosion resistance, maintaining their color and integrity under prolonged exposure to sunlight and rain. Additionally, PVDF fluorocarbon coatings exhibit strong resistance to salt spray, providing substantial anti-corrosion benefits.

However, PVDF has its drawbacks; for example, when used outdoors, if nails are driven through the PVDF-coated galvanized steel, the damaged area tends to rust. Additionally, PVDF fluorocarbon coatings require high temperatures (240-300° C.) to cure, limiting their application to factory settings and preventing direct outdoor use. The high processing temperature also restricts PVDF from being applied on titanium plates, as it can cause discoloration or deformation of the titanium, adding to the challenges in processing.

Furthermore, PVDF has relatively low hardness, around HB, and its water contact angle (hydrophobic angle) is approximately 80-90 degrees, with a water sliding angle of 40-50 degrees. This results in limited anti-fouling performance, making it insufficient for graffiti resistance or easy cleaning. The difficulty in cleaning means that maintenance personnel may need to spend a considerable amount of time to achieve cleanliness, and in seeking efficiency, they might resort to using strong acids or alkalis, which could shorten the building's lifespan or lead to wasted energy and resources.

Additionally, if a PVDF-coated galvanized steel plate is nailed down, the damaged area around the nail may rust.

Therefore, there is a need for a surface coating that can be applied over PVDF fluorocarbon coatings or directly on substrates, effectively retaining the original gloss, preventing rust, enhancing surface hardness, avoiding base coat chalking, reducing processing difficulty, and preventing discoloration and deformation. Such a coating should also be easily washable and cleanable, which forms one of the purposes of this application.

Moreover, if a colorized anti-fouling, anti-corrosion hydrophobic coating with strong adhesion to both polar and weakly polar materials could be developed, it would not require a primer and could directly bond with ferrous or non-ferrous metals, imparting suitable color and gloss to the substrate. This would enable direct application on completed sites in the aftermarket without heating or requiring in-factory processing, addressing another primary purpose of this application.

Ideally, this surface coating should be applicable directly onto substrates while also meeting the requirements for traditional methods when applied over PVDF fluorocarbon coatings.

Therefore, there is still a need for improvement in the prior art.

### SUMMARY OF THE INVENTION

To address the aforementioned and other issues, this application provides a transparent matte anti-fouling, corrosion-resistant surface coating that can be applied directly as a topcoat at ambient temperature with moisture curing, as well as a colored anti-fouling, corrosion-resistant surface coating that can be similarly applied.

Another objective of this application is to provide a transparent matte anti-fouling, corrosion-resistant surface coating, along with its applications and the formation of transparent matte anti-fouling, corrosion-resistant surface layers and transparent matte anti-fouling, corrosion-resistant metals.

Yet another objective of this application is to provide a colored anti-fouling. corrosion-resistant surface coating, its applications, and the formation of colored anti-fouling, corrosion-resistant surface layers and colored anti-fouling, corrosion-resistant metals.

The aforementioned transparent matte anti-fouling, corrosion-resistant surface coating, which can be applied as a topcoat at ambient temperature with moisture curing, may be directly applied to corrosion-prone metal panels with an underlying protective primer layer. This coating possesses properties such as anti-fouling, hydrophobicity, anti-graffiti, corrosion resistance, transparency, a transparent matte finish, resistance to thermal and impact stress, and toughness. It does not alter the original color or gloss of the substrate and can cure at ambient temperature for direct outdoor use or be heat-cured for factory application.

This transparent matte anti-fouling, corrosion-resistant coating can also be applied directly to rust-resistant metal surfaces, imparting the same anti-fouling, hydrophobic, anti-graffiti, corrosion-resistant, transparent matte, thermal shock-resistant, impact- resistant, and tough properties without altering the color or gloss of the substrate. It can be cured at ambient temperature for direct outdoor use or heat-cured for factory processing.

To achieve the aforementioned and additional objectives, this application provides an embodiment of a transparent matte anti-fouling, corrosion-resistant surface coating, comprising a fluorine-modified polysilazane copolymer, where the copolymer content accounts for about 5-80% by weight.

Preferably, the fluorine-modified polysilazane copolymer comprises a copolymerization of a fluorinated compound with a siloxane and a silazane. Specifically, the fluorinated compound constitutes about 10-30%, the siloxane about 20-30%, and the silazane about 40-70% by weight. This fluorine-modified polysilazane copolymer may be formulated from a mixture of the following exemplary copolymer types and is not limited to a single polymer.

Preferably, after copolymerizing the fluorinated compound with siloxane, the resulting compounds include, but are not limited to: poly-(heptadecafluorodecyl-methyl) siloxane, poly-(nonafluorohexyl) siloxane, poly (methyl-trifluoropropyl) siloxane, polydimethylsiloxane, hexafluoropropylene oxide, perfluoropolyether sulfonic acid, perfluoromethyl vinyl ether, polytetrafluoroethylene-perfluoromethyl vinyl ether, perfluoropropyl vinyl ether, perfluorosulfonylethyl vinyl ether, hexafluoroisobutene, perfluoroethyl vinyl ether, or hexafluoropropylene oxide trimer vinyl ether.

Preferably, the siloxane includes, but is not limited to: polydimethylsiloxane (PDMS), methyl silicone resins, cyclopentasiloxane, phenyl trimethicone, amine-terminated polydimethylsiloxane (amodimethicone), or cyclic polydimethylsiloxane (cyclomethicone).

Preferably, this transparent matte anti-fouling, corrosion-resistant surface coating applied as a topcoat at ambient temperature with moisture curing further includes a solvent.

The present application further aims to provide a transparent matte anti-fouling, corrosion-resistant surface coating, which can be applied as a topcoat by direct ambient moisture curing on a metal plate with a protective metal coating. Preferably, the protective metal coating includes, but is not limited to, fluorocarbon resin paint, silicone- modified reinforced polyester paint, silicone-modified reinforced fluorocarbon resin paint, or polyester resin paint; including, but not limited to, fluorocarbon resin (PVDF), silicone-modified polyester resin coating (Silicone Modified Polyester, SMP), silicone-modified PVDF (SMPF), or polyester resin paint (PE).

To offer additional protection, examples such as PVDF, SMP, or SMPF demonstrate that this coating can prevent chalking and reduce issues of fading and degradation. It can also prevent chalking in other acrylic-containing coatings. In addition to chalking prevention or providing extra protection, this coating can also offer features like anti-graffiti properties and ease of cleaning.

Preferably, the metal of the (corrosion-prone) metal plate includes, but is not limited to, iron, steel, galvanized steel, nickel-plated iron, magnesium-aluminum-zinc alloy, or aluminum alloy.

The present application also aims to provide a transparent matte anti-fouling, corrosion-resistant surface coating for use as a topcoat applied directly onto a (corrosion-resistant) metal plate.

Preferably, the metal of the (corrosion-resistant) metal plate includes, but is not limited to, titanium or titanium alloy.

The present application further aims to provide a transparent matte anti-fouling and corrosion-resistant surface layer, achieved by applying the aforementioned coating, which hardens through ambient moisture curing or thermal curing.

The application also aims to provide a transparent matte anti-fouling and corrosion-resistant metal, by bonding the aforementioned coating to a (corrosion-resistant) metal surface. The (corrosion-resistant) metal includes, but is not limited to, titanium or titanium alloy.

Additionally, this application aims to provide a transparent matte anti-fouling and corrosion-resistant metal by bonding the aforementioned coating to the surface of a (corrosion-prone) metal that has a protective metal coating. Preferably, the protective metal coating includes, but is not limited to, fluorocarbon resin paint, silicone-modified reinforced polyester paint, silicone-modified reinforced fluorocarbon resin paint, or polyester resin paint. Preferably, the corrosion-prone metal includes, but is not limited to, iron plates, steel plates, galvanized steel plates, nickel-plated iron plates, magnesium-aluminum-zinc alloy, or aluminum alloy.

Furthermore, to address the above and other issues, the present application aims to provide a colored anti-fouling, corrosion-resistant surface coating that can be applied as a topcoat by direct ambient moisture curing. The application also extends to the use of the colored anti-fouling, corrosion-resistant surface coating, along with colored anti-fouling and corrosion-resistant surface layers and colored anti-fouling and corrosion-resistant metals, to improve upon prior techniques.

The present application further aims to provide a colored anti-fouling and corrosion-resistant surface coating, which can be directly applied as a topcoat at ambient temperature and moisture, offering strong adhesion to both polar and weakly polar materials.

Another objective of this application is to provide a colored anti-fouling and corrosion-resistant surface coating that does not require a primer and can adhere directly to steel or non-ferrous metal surfaces, imparting suitable color and gloss to the coated objects.

Additionally, this application aims to provide a colored anti-fouling and corrosion-resistant surface coating that can be applied directly in post-market field applications without requiring heating or in-factory processing.

Another goal of this application is to offer a colored anti-fouling and corrosion-resistant surface coating that can be applied directly to coated materials and is also compatible with traditional methods, allowing application over protective metal coatings (e.g., PVDF fluorocarbon paint).

The application further aims to provide a colored anti-fouling and corrosion-resistant surface coating that can preserve the original gloss of the coated metal, prevent rust, increase surface hardness, avoid primer chalking, and reduce processing difficulty, avoiding color changes and deformation issues. It should also be easy to wash and clean.

This application further seeks to provide uses for the colored anti-fouling and corrosion-resistant surface coating, a colored anti-fouling and corrosion-resistant surface layer, and a colored anti-fouling and corrosion-resistant metal that meet the aforementioned objectives.

To achieve the aforementioned and other objectives, this application provides an embodiment of a colored anti-fouling and corrosion-resistant surface coating, directly formable at ambient temperature and moisture as a topcoat. This coating comprises the previously described transparent matte anti-fouling, corrosion-resistant surface coating and a surface-modified pigment, with the surface-modified pigment content ranging from about 0.05 to 25% by weight.

Preferably, the surface-modified pigment comprises a surface modifier and a pigment. The surface modifier may include, but is not limited to, silane, acrylamide silane, benzyl silane, urea silane, amide silane, epoxy silane, or amino silane.

The pigment preferably includes, but is not limited to, organic or inorganic pigments with color codes such as PY194, PY150, PY154, PY83, PO36, PR254, PR179, PR122, PV19, PV23, PB15-1, PB15-3, PB15-4, PG7, PG36, PW6, PBk7, PBk28, PBk33, PB28, PB28, PBr24, PBr29, PY42, PY184, PY53, PY119, PY164, PG17, and PR101. Similar colors may include Chrome Antimony Titanium Buff Rutile (PBR24-S), Bismuth Vanadate (PY184-S), Cobalt Blue (PBI28-S), Red Iron Oxide (PR101-S), and Copper Chromite Black Spinel (PBK28-S).

Preferably, the coating also contains a solvent in an amount ranging from about 35 to 85% by weight.

To achieve the aforementioned and other objectives, this application further provides an embodiment of a colored anti-fouling and corrosion-resistant surface coating that can be directly formed at ambient temperature and humidity as a topcoat. This coating is suitable for application as a topcoat on a metal sheet with a protective coating. Preferably, the metal of the sheet includes, but is not limited to, iron, steel, galvanized steel, nickel-plated iron, magnesium-aluminum-zinc alloy, aluminum, or aluminum alloy.

To achieve these and other objectives, this application further provides an embodiment of a colored anti-fouling and corrosion-resistant surface coating applied directly as a topcoat on a metal sheet. Preferably, the metal of the sheet includes, but is not limited to, titanium or titanium alloy.

To achieve these and other objectives, this application further provides an embodiment of a colored anti-fouling and corrosion-resistant surface layer, wherein the aforementioned colored anti-fouling and corrosion-resistant surface coating is applied and cured at ambient temperature and humidity or by thermal curing to form a layer.

To achieve these and other objectives, this application further provides an embodiment of a colored anti-fouling and corrosion-resistant metal, wherein the aforementioned colored anti-fouling and corrosion-resistant surface coating is combined with a metal surface. Preferably, this metal includes, but is not limited to, titanium or titanium alloy.

To achieve these and other objectives, this application further provides an embodiment of a colored anti-fouling and corrosion-resistant metal, wherein the aforementioned colored anti-fouling and corrosion-resistant surface coating is combined with a metal surface that has a protective coating. This protective coating includes, but is not limited to, fluorocarbon baked enamel, silicone-modified reinforced polyester baked enamel, silicone-modified reinforced fluorocarbon resin baked enamel, or polyester resin baked enamel. Preferably, the metal includes, but is not limited to, iron, steel, galvanized steel, nickel-plated iron, magnesium-aluminum-zinc alloy, or aluminum alloy.

### BRIEF DESCRIPTION OF DRAWINGS

None.

### DETAILED DESCRIPTION OF THE INVENTION

To make the above and other objectives, features, and advantages of the present invention more apparent, the following preferred embodiments are described in detail with reference to the accompanying drawings. The same symbols in different drawings can be considered identical and their descriptions may be omitted.

The following embodiments are described in two main categories:
1.first, the transparent matte anti-fouling and corrosion-resistant surface coating;
2.second, the colored anti-fouling and corrosion-resistant surface coating.

The primary focus of testing in these embodiments includes:
(a) coating applied to a metal surface with a protective coating layer, and
(b) coating applied to a metal surface without a protective layer.

For Test (a), the main objective is to examine whether the coating provided in this application can effectively reduce rust formation in areas where the prior art PVDF-coated metal panels develop rust upon being nailed into place.

In Test (b), the goal is to assess whether the proposed coating in this application can maintain the metal luster when applied directly on titanium panels, while avoiding discoloration and deformation—issues that arise with the direct application of PVDF to titanium at high processing temperatures. This embodiment tests if the desired effects can be achieved without requiring high temperatures.

### 1. Transparent Matte Anti-Fouling Corrosion-Resistant Surface Coating; (a)

Coating Applied to a Metal Surface with a Protective Layer

### Comparative Example 1-1:

Using Gamet Primer W from DeYa Resins as the base coating and Gamet #1000 as the top coating, the coatings were applied to a galvanized steel sheet (Yieh Phui Z27). The dry film thickness of the base coat was 5 μm, and the top coat was 20 μm. Both coatings were cured at 240° C. for 10 minutes each, resulting in the final coated panel. This panel was fastened to a wood board with screws and subjected to contact angle, sliding angle, and salt spray tests. Results indicated a water contact angle of 85±5°, a sliding angle of 55±5°, and visible rust formation around the screws after the salt spray test.

### Comparative Example 1-2:

A Yieh Phui 2C energy-saving coated steel sheet pre-coated with silicon-modified polyester resin was used as the substrate. The base coat dry film thickness and curing conditions were consistent with Comparative Example 1-1. After fastening to a wood board with screws, the coated sheet was subjected to water contact angle, sliding angle, and salt spray tests. The results were a water contact angle of 75+5°, a sliding angle of 50+5°, and visible rust formation around the screws following the salt spray test.

### Embodiment Example 1-1:

A panel from Comparative Example 1-1 was further coated with the transparent matte anti-fouling, corrosion-resistant surface coating of this application (model: HyperDurays CP series). The coating was moisture-cured at room temperature, with surface drying achieved after 1 hour and full curing after 4 hours. This panel was then fastened to a wood board with screws and subjected to water contact angle, sliding angle, and salt spray tests. Results showed a water contact angle of 107+5°, a sliding angle of 15±5°, and no rust formation around the screws after the salt spray test.

Embodiment Example 1-2:

A panel from Comparative Example 1-2 was coated with the same transparent matte anti-fouling, corrosion-resistant surface coating (model: HyperDurays CP series). The coating was moisture-cured at room temperature, with surface drying in 1 hour and full curing in 4 hours. This panel was also fastened to a wood board with screws and subjected to the same tests. Results indicated a water contact angle of 107+5°, a sliding angle of 15+5°, and no rust formation following the salt spray test.

In summary, Embodiment Examples 1-1 and 1-2 demonstrated high hydrophobicity (water contact and sliding angles) and enhanced salt spray resistance.

Therefore, the disclosed transparent matte anti-fouling, corrosion-resistant surface coating is suitable as a topcoat for metal substrates with a protective coating. Suitable protective coatings include PVDF fluorocarbon coatings, SMPF (silicon-modified PVDF), SMP (silicon-modified polyester), or PE (polyester) coatings. The metal substrates may include iron plates, aluminum plates, steel plates, galvanized steel, nickel-plated iron, or various metal panels used for curtain walls.

### 1. Transparent Matte Anti-Fouling Corrosion-Resistant Surface Coating; (b) Coating Applied to a Metal Surface without Protective Layer

### Comparative Example 1-3:

A solution containing 10% easy-clean resin (Merck 1500RC) and 90% propylene

glycol methyl ether acetate (PMA) solvent was applied as an easy-clean coating on a titanium plate (Heqiang Titanium Industry TC4). After moisture curing at room temperature, the surface was dry within 1 hour, and fully cured within 4 hours, resulting in a dry film thickness of 1 μm. The sample underwent tests for water contact angle, sliding angle, accelerated UV aging (QUV), gloss, and bendability (OT “T” Bend). Results indicated a water contact angle of 100+5°, a sliding angle of 55+5°, a 60° gloss value of 640, and a coating fracture upon T-bend testing. The QUV contact angle measurements were: <100° at 200 hours, <90° at 400 hours, and <80° at 2000 hours.

Analysis showed that, although the original untreated titanium plate had a 60° gloss of 800, the gloss value dropped to 640 after coating, resulting in some reflective issues, potentially causing light pollution on building exteriors. Although the increased contact angle indicated some easy-clean properties, the coating lacked weather resistance. Moreover, the coating fractured when applied to titanium bent at large angles for outdoor use.

### Comparative Example 1-4:

A similar coating was prepared with 10% easy-clean resin (Merck 1800RC), 90% PMA solvent, and 0.03% matting agent (Fuji Sylysia SY-350), and applied to a titanium plate (Heqiang Titanium Industry TC4). After moisture curing at room temperature, the surface was dry in 1 hour, fully cured in 4 hours, and achieved a dry film thickness of 1 um. This sample underwent the same water contact angle, sliding angle, gloss, and T-bend tests, showing a water contact angle of 100±5°, a sliding angle of 55±5°, a 60° gloss of 318, and coating fracture upon T-bend testing.

The untreated titanium plate had a 60° gloss of 800, which reduced to 318 post-coating, eliminating reflectivity. However, the matting agent, being opaque white, failed to preserve the original metallic luster of the titanium. Additionally, the coating fractured when the titanium was bent at large angles outdoors. Expansion and contraction due to temperature fluctuations could further damage the metal structure.

### Embodiment Example 1-3:

A transparent matte anti-fouling, corrosion-resistant surface coating (model: HyperDurays CP series) was applied to a titanium plate (Heqiang Titanium Industry TC4). Following moisture curing at room temperature, the surface dried within 1 hour and cured fully within 4 hours, producing a dry film thickness of 1 um. Tests on water contact angle, sliding angle, gloss, and T-bend durability showed a contact angle of 107±5°, a sliding angle of 15±5°, a 60° gloss of 540, and no coating fracture in the T-bend test. The QUV contact angle measurements were: <112° at 200 hours, <110° at 400 hours, and <108° at 2000 hours.

This example maintained a matte metallic luster on the titanium plate, with a 60° gloss value dropping from 800 to 540, effectively reducing reflectivity without causing light pollution on building exteriors. The coating exhibited easy-clean properties, weather resistance, and sufficient flexibility to avoid fracture when applied to titanium bent at large outdoor angles.

This transparent matte anti-fouling, corrosion-resistant surface coating, as disclosed in this application, is suitable for direct application on metal plates, particularly titanium alloy. It achieves its matte effect without needing additional matting agents.

To validate the technical efficacy of these embodiments, the applicant has commissioned testing at Taiwan SGS Material and Engineering Laboratory, in collaboration with the Taiwan Coatings Association and the Industrial Technology Research Institute. Tests include gloss, dry film hardness, adhesion, impact resistance, abrasion resistance, chemical resistance, dry film thickness, moisture resistance, water contact angle, cyclic corrosion, weather resistance, and salt spray testing.

TABLE 1
Testing Equipment

| Equipment Name | Brand | Model |
|---|---|---|
| micro-TRI-gloss Gloss | BYK | 4446 |
| Meter | | |
| Pencil | MITSU-BISHI uni | N/A |
| Impact Tester | BYK | 5512 |
| Humidity Tester | Custom-made | JTM-1274 |
| Cyclic Corrosion Tester | Q-LAB | Q-Fog/CRH1100HSC |
| Film Thickness Gauge | QuaNix | 8500 Basic C |
| Q-SUN Xe-3 Xenon Arc | Q-LAB | Q-SUNXe-3-HBS |
| Test Chamber | | |
| Spectrophotometer | MINOLTA | CM-3600d |
| Contact Angle Meter | ASTP | VCA Optima XE |
| Salt Spray Tester | ERICHSEN | 606/400I |

Note:
This table lists the equipment used for various performance tests on the coating, including gloss, adhesion, thickness, moisture resistance, corrosion resistance, and salt spray testing.

TABLE 2
Test Conditions

| Test Type | Parameter | Condition |
|---|---|---|
| Cyclic Corrosion Test | Test Solution | 0.05% NaCl + 0.35% |
| | | (NH₄)₂SO₄ |
| | Cycle Condition | 1-hour spray + 1-hour drying |
| | Spray Temperature (° C.) | 24 ± 3 |
| | Drying Temperature (° C.) | 35 ± 1.5 |
| | Spray Volume (ml/hr/80 cm²) | 1.0~2.0 |
| | Collected Salt Spray pH | 5.0~5.4 |
| | Sample Placement Angle | 15~30° |
| Weather Resistance | Lamp Type | Xenon Arc Lamp |
| | Filter | Daylight |
| | Irradiation Power | 0.35 W/m²/nm @340 nm |
| | Cycle Condition | 102 min light @63° C. + 18 min |
| | | spray |
| Salt Spray Test | Salt Solution | 5 wt. % Sodium Chloride |
| | | Solution |
| | Solution pH | 6.5~7.2 |
| | Chamber Temperature (° C.) | 35 ± 2 |
| | Spray Volume (ml/hr/80 cm²) | 1.0~2.0 |

TABLE 3
Test Results

| Test Item | Test Method | Test Result |
|---|---|---|
| Gloss (60°) | ASTM D523-14 (2018) | 47 |
| Dry Film Hardness (Scratch | ASTM D3363-05 (2011) | 4H |
| Method) | | |
| Adhesion | AAMA 2605-17a, ASTM | |
| | D3359-17 | |
| Dry Film | | 5B |
| Wet Film | | 5B |
| Boiling Water | | 5B |
| Impact Resistance (3 ± 0.3 mm, | AAMA 2605-17a, ASTM | No delamination observed |
| 5/8″, 134 in-lb) | D2794-93 (2019) | |
| Abrasion Resistance (L/mil.) | ASTM D968-17 A | 28 |
| Chemical Resistance | AAMA 2605-17a, ASTM | |
| | D2244-16 | |
| Hydrochloric Acid (15 mins) | | No blistering or significant |
| | | visual change |
| Mortar | | No delamination or significant |
| | | visual change |
| Detergent (3%, 72 hrs) | | No delamination, significant |
| | | visual change; adhesion 100% |
| | | retained |
| Nitric Acid (30 mins) | | No significant visual change, |
| | | ΔE = 1.15 |
| Glass Cleaner (24 hrs) | | No delamination or significant |
| | | visual change; adhesion 100% |
| | | retained |
| Dry Film Thickness | ASTM D7091-13 | 16.2 |
| Moisture Resistance | AAMA 2605-17a | No visual abnormalities |
| Water Repellency Angle | ASTM D7334-08 (2013) | 111.1 ± 1.2 |
| Cyclic Corrosion Test (2000 | AAMA 2605-17a, ASTM G85- | |
| hrs) | 11, ASTM D7334-08 (2013) | |
| Appearance | | No visual abnormalities |
| Water Contact Angle (°) | | 105.3 ± 0.6 |
| Weather Resistance | ASTM G155-13, ASTM D523- | |
| | 14 (2018), ASTM D4214-07 | |
| | (2015), ASTM D7334-08 | |
| | (2013) | |
| Appearance | | No visual abnormalities |
| Gloss Retention (%) | | 76.6 |
| Chalk Resistance | | No chalking |
| Water Contact Angle (°) | | 103.8 ± 1.3 |
| Salt Spray Test (4000 hrs) | ASTM B117-18, ASTM | No rust observed visually |
| | D7334-08 (2013) | |

In summary, this exemplary transparent matte anti-stain, anti-graffiti, and corrosion-resistant surface coating includes a fluorinated modified polysilazane, allowing it to be directly applied to a corrosion-prone metal substrate with a protective base coating. The coating offers properties such as stain resistance, hydrophobicity, anti-graffiti capability, corrosion resistance, transparency, matte transparency, thermal and impact resistance, and flexibility, without altering the color or gloss of the substrate. The coating can harden at room temperature for direct outdoor use or can be heat-cured for in-factory processing. Additionally, this transparent matte anti-stain, anti-graffiti, and corrosion-resistant coating can be applied directly onto rust-resistant metal surfaces, either with or without the addition of a matting agent, while still retaining the aforementioned matte transparency and properties.

### 2. Colored Anti-Stain and Corrosion-Resistant Surface Coating; (a). Coating Applied to a Metal Surface with a Protective Coating

### Comparative Example 2-1:

A galvanized steel plate (Yieh Phui Z27) was coated with Gamet Primer W (base coat) from Dea Resin and Duranar fluorocarbon topcoat from PPG, with a base coat dry film thickness of 7 um and a topcoat thickness of 25 μm. The base coat was cured at 240° C. for 10 minutes, and the topcoat at 250° C. for 15 minutes. After securing the coated panel to a wooden board with screws, tests for water contact angle, sliding angle, and salt spray resistance were conducted, yielding the following results: water contact angle of 82±5°, sliding angle of 53±5°, and visible rust around the screws in the salt spray test.

### Comparative Example 2-2:

A stainless steel plate (Yieh Hsing Li Hua 2B cold-rolled) was coated with Gamet Primer W2 from Dea Resin as the base coat and GAMET #1000 fluorocarbon topcoat. The base coat had a dry film thickness of 5 um, and the topcoat was 20 um thick. Both coatings were cured at 240° C. for 10 minutes. After attaching the finished plate to a wooden board with screws, tests for water contact angle, sliding angle, and salt spray resistance were performed, resulting in a water contact angle of 85±5°, sliding angle of 55±5°, and minor rust around the screws in the salt spray test.

### Embodiment Example 2-1:

A galvanized steel plate (Yieh Phui Z27) was coated with HyperDurays RG—PBR24 from this example (surface-modified pigment PBR24-S 5%, fluorinated modified polysilazane 50%, PMA solvent 45%). The dry film thickness was 15 μm, and the coating was cured by exposure to ambient moisture for 1 hour to reach touch-dry condition, with full curing in 4 hours. After securing the coated panel to a wooden board with screws, tests for water contact angle, sliding angle, salt spray resistance, QUV weather resistance (accelerated UV aging), and bending (OT “T” Bend) were conducted. Results showed a water contact angle of 103±5°, sliding angle of 12±3°, no rust in the salt spray test, and QUV weather resistance with water contact angles of <108° after 200 hours, <106° after 400 hours, and <103° after 2000 hours.

### Embodiment Example 2-2:

A stainless steel plate (Yieh Hsing Li Hua 2B cold-rolled) was coated with

HyperDurays RG-PBI28 from this example (surface-modified pigment PBI28-S 0.1%, fluorinated modified polysilazane 5%, PMA solvent 94.9%). The dry film thickness was 5 um, and the coating was cured by exposure to ambient moisture for 1 hour to reach touch-dry condition, with full curing in 4 hours. After attaching the coated plate to a wooden board with screws, tests for water contact angle, sliding angle, salt spray resistance, QUV weather resistance, and OT T-Bend were conducted, yielding a water contact angle of 105±5°, sliding angle of 10±3°, no rust in the salt spray test, and QUV weather resistance with water contact angles of <110° after 200 hours, <109° after 400 hours, and <105° after 2000 hours.

### 2. Colored Anti-Stain and Corrosion-Resistant Surface Coating; (b). Coating Applied to a Metal Surface Without a Protective Coating

### Comparative Example 2-3:

A red coating solution was prepared using 20% easy-clean resin (Merck 1500RC),

79.5% PMA solvent (propylene glycol methyl ether acetate), and 0.5% PR101 pigment. This coating was applied to a titanium plate (Heqiang Titanium Industry TC4) with a dry film thickness of 15 μm. The coating was cured by ambient moisture exposure, drying to the touch in 1 hour and fully cured in 4 hours. Tests for water contact angle, sliding angle, accelerated UV aging (QUV weathering), and bending (OT “T” Bend) were conducted. Results were as follows: water contact angle of 100±5°, sliding angle of 55±5°, and T-bend testing showed cracking of the coating. For QUV testing, water contact angles were <100° after 200 hours, <90° after 500 hours, and <75° after 2000 hours. This indicates that although the red coating could be applied as a single layer to achieve an easy-clean effect, the non-surface-modified pigment affected durability, making it less weather-resistant, with cracking observed in outdoor applications where the titanium plate was bent at larger angles.

### Embodiment Example 2-3:

A titanium plate (Heqiang Titanium Industry TC4) was coated with HyperDurays RG-0226 from this example (3% surface-modified pigment PR-101, 35% fluorinated modified polysilazane, and 62% PMA solvent), resulting in a dry film thickness of 10 um. The coating was cured by ambient moisture exposure, drying to the touch in 1 hour and fully cured in 4 hours. After securing the coated plate to a wooden board with screws, tests for water contact angle, sliding angle, salt spray resistance, QUV weathering, and OT T-Bend were conducted. Results were as follows: water contact angle of 104±5°, sliding angle of 11±3°, no rust in the salt spray test, and QUV testing with water contact angles of <109° after 200 hours, <108° after 400 hours, and <104° after 2000 hours.

This indicates the coating's enhanced performance in terms of both weather resistance and durability when subjected to outdoor conditions.

### Summary of Comprehensive Properties of HyperDurays RG in Embodiment Examples.

TABLE 4
Properties of HyperDurays RG in Embodiment Examples.

| Property | Specification |
|---|---|
| Film Thickness | 3-20 μm |
| Bending | 0-1 T |
| Water Sliding Angle | 10-12° |
| Stain Resistance/Graffiti Resistance | Passed |
| Hardness | 1-2H |
| Water Contact Angle | 103-105° |

The additional properties of this colored anti-stain and corrosion-resistant surface coating can be referenced in the previous examples of the transparent matte anti-stain and corrosion-resistant surface coating and will not be redundantly described here.

In summary, this example discloses a colored, anti-stain, corrosion-resistant hydrophobic coating with strong adhesion properties to both polar and weakly polar substrates. It can adhere directly to steel and non-ferrous metal surfaces without primer and can be applied post-market without heat or factory processing, offering suitable color and gloss to the coated object.

Additionally, the coating in this example, containing fluorine-modified polysilazane resin, surface-modified pigments, fillers, additives, and solvents without traditional fluorocarbon structure, demonstrates high adhesion, stain resistance, graffiti resistance, cyclic corrosion resistance, salt spray resistance, weather resistance, hydrophobicity, oleophobicity, high-temperature resistance, thermal shock durability, and both hardness and flexibility. It cures at low energy levels, reducing energy consumption, lowering the carbon footprint, and reducing processing steps and time. It also enhances the maintenance aspect, reducing water and detergent use for cleaning, aligning with ESG principles.

Furthermore, for non-ferrous metals (such as stainless steel, aluminum alloys, and titanium alloys), this example coating can adhere directly without requiring surface modification treatments. With a film thickness of 3-20 μm, it can provide diverse colors (semi-transparent or full coverage), gloss options (high gloss or matte), and anti-stain, hydrophobic, oleophobic, and easy-clean characteristics. During architectural renovations, it simplifies paint removal for recycling non-ferrous metals, supporting circular economy goals and reducing carbon emissions.

Thus, the anti-stain, corrosion-resistant surface coating in this example includes both a transparent matte and a colored variant, both based on fluorine-modified polysilazane technology. Depending on the presence of surface-modified pigments, those skilled in the field may choose to implement either the transparent or colored anti-stain, corrosion-resistant surface coating.

The disclosed anti-stain, corrosion-resistant surface coatings can further extend to related applications, surface layers, and coated metals. Accordingly, the transparent matte series discloses a transparent matte anti-stain and corrosion-resistant surface coating, its application, surface layer, and metal; the colored series discloses a colored anti-stain and corrosion-resistant surface coating, its application, surface layer, and metal.

Additionally, the proposed formulation can cure under ambient moisture at room temperature, eliminating the need for heat curing and allowing direct on-site application. This reduces energy use, lowers carbon footprint, and minimizes processing steps. The formulation can also be applied to low-melting substrates across a broad range of materials.

With ambient hardening technology for outdoor use, this formulation adheres directly to steel or non-ferrous metals without a primer, providing suitable color and gloss, and is tailored for direct application to metals post-market without factory processing or additional heat.

1. A transparent matte anti-stain and corrosion-resistant surface coating, formable as a topcoat at ambient humidity, comprising: a fluorinated modified polysilazane copolymer, wherein the fluorinated modified polysilazane copolymer is present in an amount of 5% to 80% by weight, and wherein the fluorinated modified polysilazane copolymer comprises a fluorinated compound copolymerized with a siloxane and a polysilazane, wherein the fluorinated compound is present in an amount of 10% to 30% by weight, the siloxane is present in an amount of 20% to 30% by weight, and the polysilazane is present in an amount of 40% to 70% by weight; wherein the fluorinated compound copolymerized with the siloxane includes poly-heptadecafluorodecyl-methylsiloxane, poly-nonafluorohexyl-siloxane, poly-methyl-trifluoropropyl-siloxane, polydimethylsiloxane, hexafluoropropylene oxide, perfluoropolyether sulfonic acid, perfluoromethyl vinyl ether, polytetrafluoroethylene perfluoromethyl vinyl ether, perfluoropropyl vinyl ether, perfluorosulfonyl vinyl ether, hexafluoroisobutylene, perfluoroethyl vinyl ether, or hexafluoropropylene oxide trimer vinyl ether; and wherein the siloxane includes polydimethylsiloxane, methylsiloxane resin, cyclopentasiloxane, phenyltrimethylpolysiloxane, amino-terminated polydimethylsiloxane, or cyclic polydimethylsiloxane.

2. The surface coating according to claim 1, further comprising a solvent.

3. The surface coating according to claim 1, applied on a metal plate with a protective metal coating layer on its surface.

4. The surface coating according to claim 3, wherein the protective metal coating layer includes fluorocarbon resin baked coating, silicone-modified reinforced polyester baked coating, silicone-modified reinforced fluorocarbon resin baked coating, or polyester resin baked coating.

5. The surface coating according to claim 3, wherein the metal of the metal plate comprises iron, steel, galvanized steel, nickel-plated iron, magnesium-aluminum-zinc alloy, or aluminum alloy.

6. The surface coating according to claim 1, directly applied on a metal plate.

7. The surface coating according to claim 6, wherein the metal of the metal plate comprises titanium or a titanium alloy.

8. A colored anti-stain and corrosion-resistant surface coating, formable as a topcoat at ambient humidity, comprising: the transparent matte anti-stain and corrosion-resistant surface coating according to claim 1, and a surface-modifying pigment, wherein the surface-modifying pigment is present in an amount of 0.05% to 25% by weight.

9. The surface coating according to claim 8, wherein the surface-modifying pigment comprises a surface-modifying agent and a pigment.

10. The surface coating according to claim 9, wherein the surface-modifying agent comprises silane, acrylamide silane, benzyl silane, urea silane, amide silane, epoxy silane, or amino silane.

11. The surface coating according to claim 9, wherein the pigment comprises organic or inorganic pigments with color index numbers including PY194, PY150, PY154, PY83, PO36, PR254, PR179, PR122, PV19, PV23, PB15-1, PB15-3, PB15-4, PG7, PG36, PW6, PBk7, PBk28, PBk33, PB28, PB28, PBr24, PBr29, PY42, PY184, PY53, PY119, PY164, PG17, or PR101.

12. The surface coating according to claim 8, further comprising a solvent.

13. The surface coating according to claim 8, applied on a metal plate with a protective metal coating layer on its surface.

14. The surface coating according to claim 13, wherein the protective metal coating layer includes fluorocarbon resin baked coating, silicone-modified reinforced polyester baked coating, silicone-modified reinforced fluorocarbon resin baked coating, or polyester resin baked coating.

15. The surface coating according to claim 13, wherein the metal of the metal plate comprises iron, steel, galvanized steel, nickel-plated iron, magnesium-aluminum-zinc alloy, aluminum, or aluminum alloy.

16. The surface coating according to claim 8, directly applied on a metal plate.

17. The surface coating according to claim 16, wherein the metal of the metal plate comprises titanium or a titanium alloy.
